(19) United States
(12) Patent Application Publication
(10) Pub. No.: US 2006/0026331 A1
(43) Pub. Date: Feb. 2, 2006

(54) Data transfer device, data transfer method, and information processing apparatus

(75) Inventors: Seiji Kikuchi, Shinagawa (JP); Masahiro Tsuchibuchi, Shinagawa (JP); Noboru Nishimura, Shinagawa (JP); Hiroaki Morimoto, Shinagawa (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 10/998,593

(22) Filed: Nov. 30, 2004

(30) Foreign Application Priority Data
Jul. 30, 2004 (JP) 2004-223730

(51) Int. Cl. G06F 13/20

(52) U.S. Cl. 710/313

(57) ABSTRACT

A data transfer device for preventing a PCI-X bus from hanging up, which can be caused when a sender of data aborts. An abort signal-receiving section receives an abort signal delivered by the sender of data when the sender aborts. When the abort signal-receiving section receives the abort signal, a dummy data-generating section generates dummy data. When the abort signal-receiving section receives the abort signal, an erroneous parity data-generating section generates erroneous parity data for indicating that the dummy data generated by the dummy data-generating section is a dummy. A data-transmitting section transmits the dummy data generated by the dummy data-generating section and the erroneous parity data generated by the erroneous parity data-generating section, to a recipient of the data via the PCI-X bus.

### CROSS-REFERENCE TO RELATED APPLICATIONS

This application is based upon and claims the benefits of priority from the prior Japanese Patent Application No. 2004-223730, filed on Jul. 30, 2004, the entire contents of which are incorporated herein by reference.

### BACKGROUND OF THE INVENTION

1. Field of the Invention

This invention relates to a data transfer device, a data transfer method, and an information processing apparatus, and more particularly to a data transfer device, a data transfer method, and an information processing apparatus, for transferring data via a PCI-X bus.

2. Description of the Related Art

A PCI-X bus is one of known bus standards for connecting between devices. The PCI-X bus has an architecture having an upward compatibility with a PCI bus, and is compatible with a bus speed of 133 MHz at the maximum, thereby realizing a transfer speed of approximately 1 G bytes/second. It should be noted that as a technique related to the PCI bus, there has been proposed a computer system in which a device requests a memory to read out data, and even if a parity error occurs in the data read out from the memory, a system failure is prevented from occurring immediately after the occurrence of the parity error, to thereby improve the computer system in the average system failure interval (see e.g. Japanese Laid-Open Patent Publication (Kokai) No. 2001-273200 (Paragraph Nos. [0011] to [0015]; FIG. 1)). Further, there has been proposed a system including a PCI slave which responds to a frame signal asserted by a PCI master, within a predetermined time period, without requesting the generation of a target abort on a PCI bus in response to an address parity error (see e.g. Japanese Laid-Open Patent Publication (Kokai) No. H08-235104 (Paragraph Nos. [0021] to [0028]; FIG. 3)).

When data transfer between devices is to be stopped, in the PCI bus, it is possible to stop the data transfer at any address, whereas in the PCI-X bus, it is possible to stop the data transfer only at a boundary (ADB: Allowable Disconnect Boundary) formed by an address of which all the lower 7 bits are 0, due to the standards of the PCI-X bus.

FIG. 7 is a diagram useful in explaining the ADB.

Reference numeral 101 in FIG. 7 designates an address space of data transferred via the PCI-X bus. The data width of the address space 101 is 64 bits, and the address space 101 is 8 G bytes (64 bits). It should be noted that in FIG. 7, only the lower 10 bits of each address are shown.

As described hereinabove, in the PCI-X bus, it is possible to stop data transfer only at the ADB. Therefore, in the address space 101 shown in FIG. 7, data transfer can be stopped only at 10′h000, 10′h080, 10′h100, 10′h180, and so forth, of which all the lower 7 bits are 0. This means that when data transfer is started between devices, it is required to continue the transfer operation until next ADB, or until completion of transfer of all the data to be transferred.

### SUMMARY OF THE INVENTION

In a first aspect of the present invention, there is provided a data transfer device for transferring data via a PCI-X bus. This data transfer device is characterized by comprising an abort signal-receiving section that receives an abort signal from a sender of the data, a dummy data-generating section that generates dummy data when the abort signal is received, an erroneous parity data-generating section that generates erroneous parity data for indicating that the dummy data is a dummy, and a data-transmitting section that transmits the dummy data and the erroneous parity data to a recipient of the data via the PCI-X bus.

Further, in a second aspect of the present invention, there is provided a data transfer method for a data transfer device, for transferring data via a PCI-X bus. This data transfer method is characterized by comprising the steps of generating dummy data, and erroneous parity data for indicating that the dummy data is a dummy, when an abort signal is received from a sender of the data, and transmitting the dummy data and the erroneous parity data via the PCI-X bus to a recipient of the data.

Further, in a third aspect of the present invention, there is provided an information processing apparatus for transferring data via a PCI-X bus. This information processing apparatus is characterized by comprising an abort signal-receiving section that receives an abort signal from a sender of the data, a dummy data-generating section that generates dummy data when the abort signal is received, an erroneous parity data-generating section that generates erroneous parity data for indicating that the dummy data is a dummy, and a data-transmitting section that transmits the dummy data and the erroneous parity data to a recipient of the data via the PCI-X bus.

The above and other features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a diagram schematically showing the arrangement of a data transfer device according to the present invention;

FIG. 2 is a diagram showing an example of the configuration of a system using a master device that performs data transfer;

FIG. 3 is a functional block diagram illustrating functions of the master device;

FIG. 4 is a timing diagram showing operations of a PCI-X bus;

FIG. 5 is a diagram useful in explaining signals on the PCI-X bus;

FIG. 6 is a flowchart showing a flow of a data transfer process; and

FIG. 7 is a diagram useful in explaining an ADB.

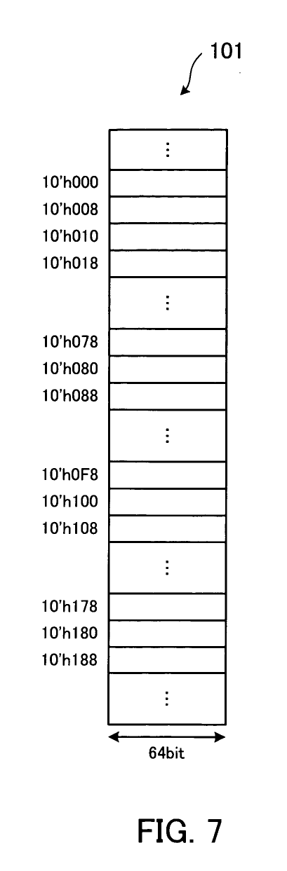

### DESCRIPTION OF THE PREFERRED EMBODIMENTS

In the Description of the Related Art, however, when the sender of data aborts during transfer thereof at other than the ADBs, a data transfer device transferring the data via the PCI-X bus has to interrupt the data transfer operation at other than the ADBs. This causes a protocol violation and hence there is a possibility that the PCI-X bus hangs up.

The present invention has been made in view of the above points, and an object thereof is to provide a data transfer device, a data transfer method, and an information processing apparatus, for avoiding a protocol violation and thereby preventing a PCI-X bus from hanging up.

The principles and a preferred embodiment of the present invention will now be described in detail with reference to the accompanying drawings.

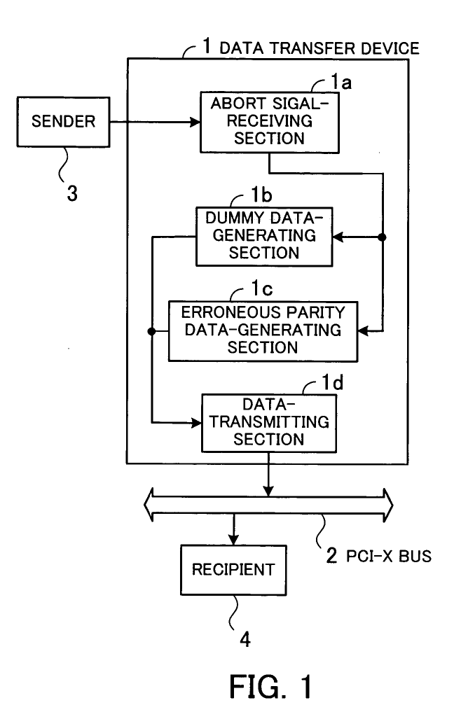

First, the principles of the present invention will be described with reference to FIG. 1, which schematically shows the arrangement of a data transfer device according to the present invention.

The data transfer device 1 shown in FIG. 1 transfers data from a sender 3 to a recipient 4 via a PCI-X bus 2. The data transfer device 1 includes an abort signal-receiving section 1a, a dummy data-generating section 1b, an erroneous parity data-generating section 1c, and a data-transmitting section 1d.

The abort signal-receiving section 1a receives an abort signal delivered by the sender 3 when it aborts.

The dummy data-generating section 1b generates dummy data when the abort signal-receiving section 1a receives the abort signal.

When the abort signal-receiving section 1a receives the abort signal, the erroneous parity data-generating section 1c generates erroneous parity data to indicate that the data generated by the dummy data-generating section 1b is a dummy. Although the recipient 4 receives the dummy data, the erroneous parity data enables the recipient 4 to recognize that the received data is a dummy.

The data-transmitting section 1d transmits the dummy data generated by the dummy data-generating section 1b and the erroneous parity data generated by the erroneous parity data-generating section 1c, to the recipient 4 via the PCI-X bus 2.

As described above, the data transfer device 1 is configured such that when an abort signal is received from the sender 3, dummy data and erroneous parity data are transmitted as remaining data to be transmitted. This makes it possible to complete transfer of data, avoid occurrence of a protocol violation, and prevent the PCI-X bus 2 from hanging up.

Next, the preferred embodiment of the present invention will be described in detail with reference to the accompanying drawings.

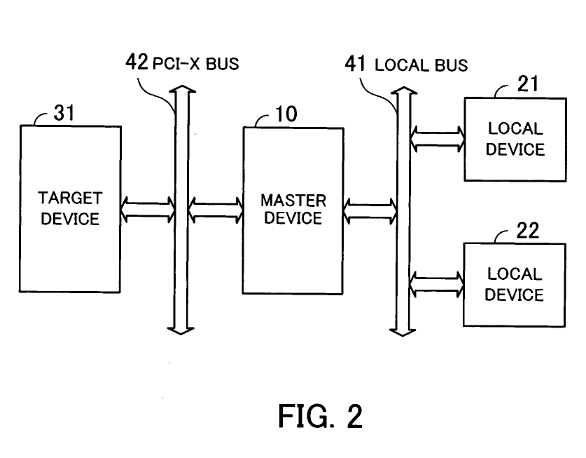

FIG. 2 shows an example of the configuration of a system using a master device that performs data transfer.

As shown in FIG. 2, the master device 10 is connected to local devices 21 and 22 via a local bus 41. Further, the master device 10 is connected to a target device 31 via a PCI-X bus 42.

The system shown in FIG. 2 is applied e.g. to an information processing apparatus of personal computers and servers. The local devices 21 and 22 represent e.g. a CPU (Central Processing Unit) and a RAM (Random Access Memory) of the information processing apparatus, and the master device 10 bridges the local bus 41 to which the local devices 21 and 22 are connected and the PCI-X bus 42 to which the target device 31 is connected, to thereby transfer data from the local devices 21 and 22 to the target device 31.

The master device 10 transfers data from the local devices 21 and 22 to the target device 31 via the PCI-X bus 42. The master device 10 makes requests to the local devices 21 and 22 to read data, and receives the data from the local devices 21 and 22. The master device 10 converts the format of the received data such that the data can be transferred via the PCI-X bus 42, and then transmits the data to the target device 31. However, when the local device 21 or 22 (i.e. one of the local devices 21 and 22, as a data sender) aborts due to an abnormal condition thereof, and transmit an abort signal to the master device 10, the master device 10 transfers dummy data and erroneous parity data to the target device 31 as remaining data to be transferred. In the present embodiment, the master device 10 is implemented by a single chip semiconductor device. However, not only the master device 10 but also the local devices 21 and 22 and the local bus 41 may be implemented by the single chip semiconductor device.

The local devices 21 and 22 locally receive and transmit data via the local bus 41 to thereby perform predetermined processing. The target device 31 receives the data from the local devices 21 and 22, which are transferred by the master device 10, via the PCI-X bus 42.

Next, the functions of the master device 10 will be described.

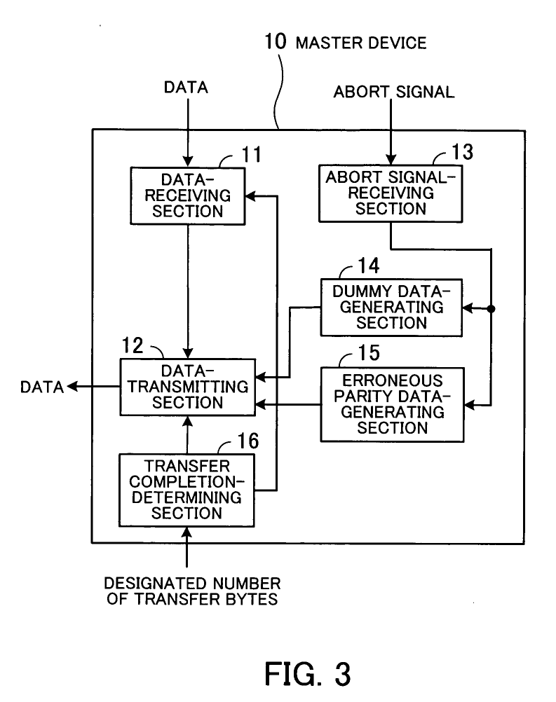

FIG. 3 is a functional block diagram illustrating the functions of the master device.

As shown in FIG. 3, the master device 10 includes a data-receiving section 11, a data-transmitting section 12, an abort signal-receiving section 13, a dummy data-generating section 14, an erroneous parity data-generating section 15, and a transfer completion-determining section 16.

The data-receiving section 11 makes requests via the local bus 41 to the local device 21 or 22 to read data, and receives the data from the local device 21 or 22. The data received by the data-receiving section 11 is delivered to the data-transmitting section 12.

The data-transmitting section 12 transmits the data received by the data-receiving section 11 to the target device 31 via the PCI-X bus 42. At this time, the data-transmitting section 12 transmits the data after converting the format of the data to a format conforming to the standards of the PCI-X bus. Further, when an abort signal is received by the abort signal-receiving section 13, the data-transmitting section 12 transmits dummy data generated by the dummy data-generating section 14 and erroneous parity data generated by the erroneous parity data-generating section 15, to the target device 31. Further, when it is determined by the transfer completion-determining section 16, described in more detail hereinafter, that a designated number of data and dummy data for transfer have been transmitted, the data-transmitting section 12 terminates the transfer of the dummy data and the erroneous parity data.

The abort signal-receiving section 13 receives an abort signal from the local devices 21 and 22 via the local bus 41. The abort signal is delivered by the local device 21 or 22, e.g. when it cannot normally deliver data for transfer to the target device 31 due to occurrence of an abnormality. The abort signal-receiving section 13 delivers a message notifying reception of the abort signal to the dummy data-generating section 14 and the erroneous parity data-generating section 15.

When the abort signal-receiving section 13 receives the abort signal, the dummy data-generating section 14 generates dummy data, and delivers the dummy data to the data-transmitting section 12. It should be noted that the contents of the dummy data are not called in question since the dummy data is only required to be indicated by erroneous parity data that it is a dummy, as will be described next.

When the abort signal-receiving section 13 receives the abort signal, the erroneous parity data-generating section 15 generates erroneous parity data which indicates that the dummy data generated by the dummy data-generating section 14 is a dummy (error). The erroneous parity data-generating section 15 delivers the generated erroneous parity data to the data-transmitting section 12.

The transfer completion-determining section 16 receives information of a designated number of transfer bytes from the local device 21 or 22 via the local bus 41. The term “designated number of transfer bytes” is intended to mean a designated number of bytes of data to be transferred from the local device 21 or 22 to the target device 31. The information of the designated number of transfer bytes is transmitted from the local device 21 or 22 to the master device 10 at the start of transfer of data. It should be noted that the transfer completion-determining section 16 stores the information of the received designated number of transfer bytes e.g. in a storage device, such as a register. Further, the transfer completion-determining section 16 transmits the information of the received designated number of transfer bytes to the target device 31.

The transfer completion-determining section 16 counts the number of bytes of data transmitted from the data-transmitting section 12 to the target device 31, and determines with reference to the information of the designated-number of transfer bytes stored in the storage device whether or not the data-transmitting section 12 has transmitted the designated number of transfer bytes of data. If the designated number of transfer bytes of data have not been transferred, the transfer completion-determining section 16 causes the data-receiving section 11 to request the local device 21 or 22 to read next data to be transferred. If the designated number of transfer bytes of data have been transferred, the transfer completion-determining section 16 carries out a process for terminating the data transfer process.

When the transfer completion-determining section 16 determines whether or not the designated number of transfer bytes of data have been transmitted, the number of bytes of transferred dummy data is also counted into the total number of transfer bytes of data. More specifically, even after the local device 21 or 22 aborts, dummy data is generated, and the data transfer process is terminated after the designated number of transfer bytes of data including the dummy data are transferred. As a result, since transfer of all the data is completed without being interrupted, it is possible to avoid a protocol violation and thereby prevent the PCI-X bus 42 from hanging up.

It should be noted that the target device 31 receives data from the master device 10 via the PCI-X bus 42. The target device 31 performs a parity check of the received data. As a result of the parity check, when it is judged that a parity error has occurred, the target device 31 notifies the master device 10 of the parity error. Upon reception of the notification of occurrence of the parity error, the master device 10 carries out a data retransfer process for retransferring data after completion of transfer of the designated number of transfer bytes of data.

When the local device 21 or 22 aborts, dummy data and erroneous parity data are transmitted from the master device 10 to the target device 31. The target device 31 detects a parity error based on the erroneous parity data, and notifies the master device 10 of the parity error. Then, the data retransfer process is performed by the master device 10.

Next, the operation of the PCI-X bus 42 will be described using a timing diagram.

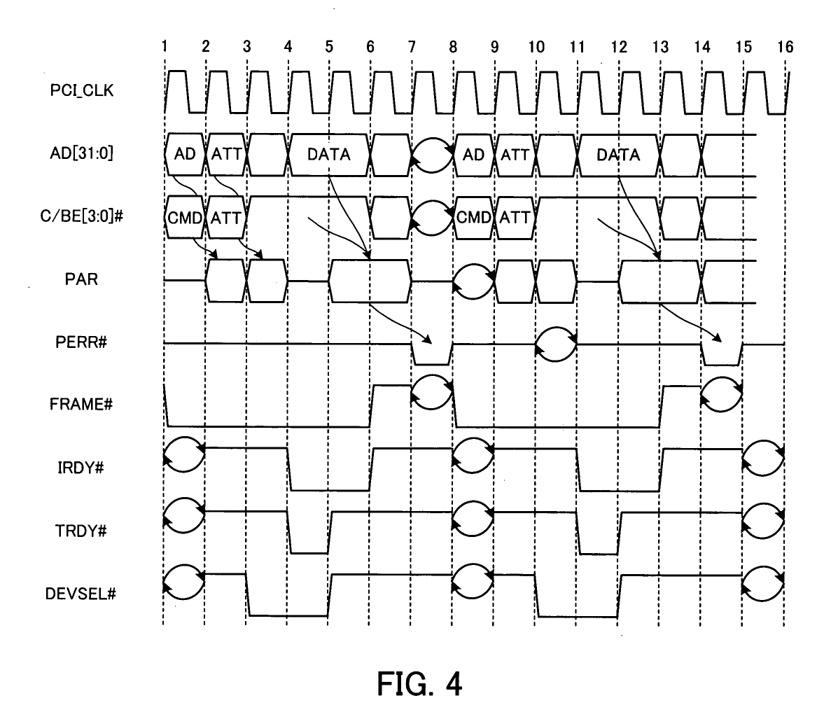

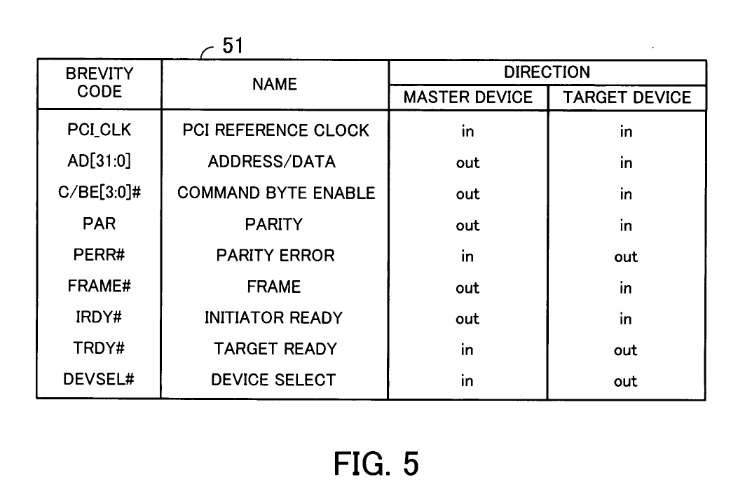

FIG. 4 is a timing diagram showing operations of the PCI-X bus, and FIG. 5 is a diagram useful in explaining signals on the PCI-X bus.

The timing diagram illustrated in FIG. 4 shows a case where the data width is 32 bits. FIG. 5 shows a table 51 useful in explaining signals appearing in FIG. 4. The symbol # used in FIG. 4 and FIG. 5 indicates that signals designated by brevity codes with the symbol # attached thereto are low-active, i.e. asserted when they are in an “L” state and deasserted when they are in an “H” state. Further, marks each formed by closed circular arrows in FIG. 4 indicates respective bus turn-arounds, during which the PCI-X bus 42 is placed in a high impedance or neutral state. Accordingly, during each of these cycles, the master device 10 and the target device 31 are in an undriven state.

“PCI_CLK” in FIG. 4 represents a reference clock according to which the PCI-X bus 42 operates, as shown in the table 51 in FIG. 5. The reference clock is inputted to the master device 10 and the target device 31. “AD[31:0]” represents a signal indicative of an address and data outputted to the PCI-X bus 42. The signal indicative of the address and data is outputted from the master device 10 and inputted to the target device 31. This signal is transmitted by sharing the address and data between thirty-two signal lines of the same type. When the address and data have a 64-bit width, they are divided into upper 32 bits and lower 32 bits for transmission. “C/BE[3:0]#” represents a signal indicative of a command byte enable. The signal indicative of the command byte enable is outputted from the master device 10 and inputted to the target device 31. “PAR” represents a signal indicative of a parity bit of data outputted by the signals “AD[31:0]” and “C/BE[3:0]#.” The signal indicative of the parity bit is outputted from the master device 10 and inputted to the target device 31. “PERR#” represents a signal indicative of a parity error. This signal is outputted from the target device 31 and inputted to the master device 10. “FRAME#” represents a frame signal. The frame signal is outputted from the master device 10 and inputted to the target device 31. “IRDY#” represents a signal indicative of “Initiator Ready.” The signal indicative of “Initiator Ready” is outputted from the master device 10 and inputted to the target device 31. “TRDY#” represents a signal indicative of “Target Ready.” The signal indicative of “Target Ready” is outputted from the target device 31 and inputted to the master device 10. “DEVSEL#” represents a signal indicative of “Device Select.” The signal indicative of “Device Select” is outputted from the target device 31 and inputted to the master device 10.

In FIG. 4, when a first pulse (pulse 1) of the reference clock “PCI_CLK” is generated, the master device 10 outputs the address (AD) of a recipient by the signal “AD[31:0].” Further, the master device 10 outputs a transfer command (CMD) by the signal “C/BE[3:0]#.” Further, the master device 10 asserts the frame signal “FRAME#.”

When a second pulse (pulse 2) of the reference clock “PCI_CLK” is generated, the master device 10 outputs attributes (ATT) by the signals “AD[31:0]” and “C/BE[3:0]#.” The attributes are information including a device ID, the number of transfer bytes, and so forth. Further, the master device 10 outputs the parity bit (PAR) of the transfer command outputted by the signal “C/BE[3:0]#.”

Now, according to the standards of the PCI-X bus, the number of bytes of data permitted to be transferred at a time is limited to 4096 at the maximum. In the PCI-X bus, the master device 10 is required to designate in advance the number of bytes of data desired to be transferred to the target device, and a phase during which the designation is performed is the attribute phase. Since 4096 bytes are represented by 12 bits, the lower 8 bits of the 12 bits are set to “AD[7:0]” as a part of the signal AD[31:0], and the higher 4 bits thereof are set to the signal “C/BE[3:0]#.”

When a third pulse (pulse 3) of the reference clock “PCI_CLK” is generated, the master device 10 outputs a parity bit (PAR) of the attributes that the master device 10 has outputted by the signal part “AD[7:0]” and the signal “C/BE[3:0]#.” The target device 31 receives the address delivered from the master device 10 to assert the signal “DEVSEL#.”

When fourth and fifth pulses (pulse 4 and pulse 5) of the reference clock “PCI_CLK” are generated, the master device 10 outputs data (DATA) by the signal “AD[31:0].” Simultaneously with the output of the data, the master device 10 asserts the signal “IRDY#.” This enables the target device 31 to recognize that the data is transferred, and hence the target device 31 asserts the signal “TRDY#.” It should be noted that data is required to be outputted over 2 cycles according to the standards of the PCI-X bus.

When the fifth pulse (pulse 5) of the reference clock “PCI_CLK” is generated, the target device 31 has received the designated number of transfer bytes of data designated by the attributes to thereby deassert the signals “TRDY#” and “DEVSEL#.”

At the pulses 5 and 6 of the reference clock, the master device 10 outputs the parity bit of the data. It should be noted that each parity bit is necessarily outputted one cycle after data as an object to be calculated.

When the sixth pulse of the reference clock “PCI_CLK” is generated, the master device 10 deasserts the signals “FRAME#” and “IRDY#” since it has transmitted the designated number of transfer bytes of data designated by the attributes.

When the seventh pulse (pulse 7) of the reference clock “PCI_CLK” is generated, the target device 31 calculates the parity of the data that it has received, and compares the calculated parity of the data and the information of the parity that it has received, with each other. If a parity error has occurred, the target device 31 asserts the signal “PERR#.”The PCI-X bus 42 operates as described above, whereby data is transferred from the master device 10 to the target device 31.

Next, operations of the data transfer process carried out by the master device 10, one of the local devices 21 and 22, and the target device 31 will be described with reference to a flowchart.

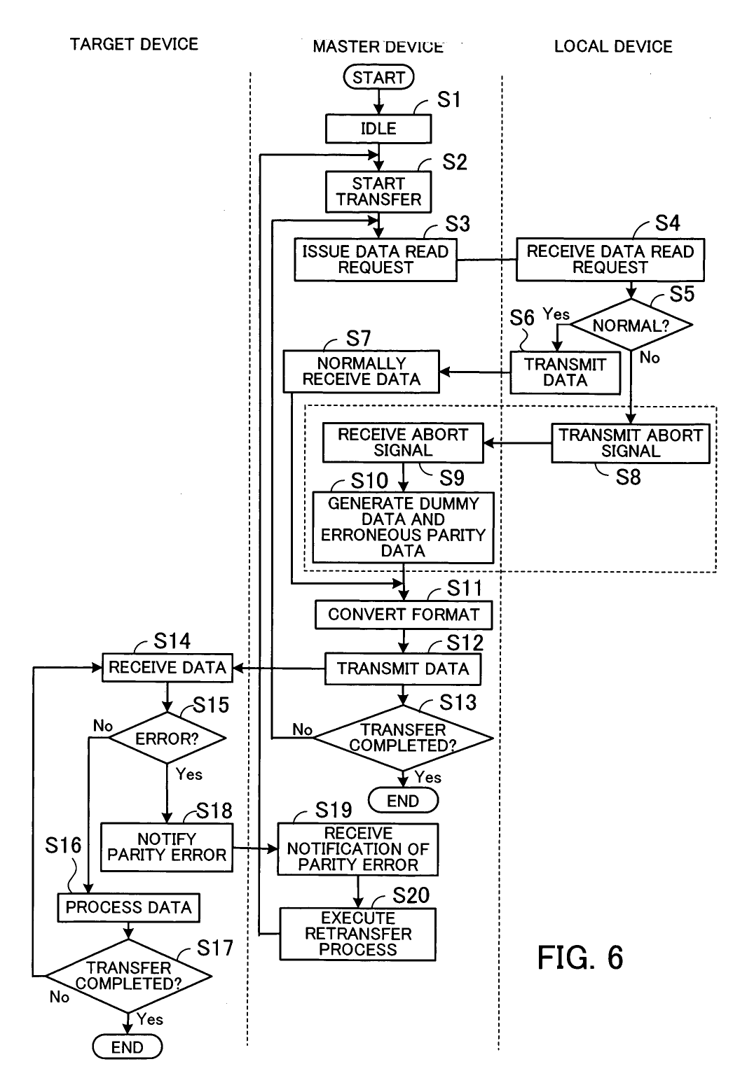

FIG. 6 is a flowchart showing a flow of the data transfer process.

In a step S1, the master device 10 is in an idle state.

In a step S2, the master device 10 starts the data transfer process in response to a data transfer request from one of the local devices 21 and 22. At this time, the master device 10 receives information of a designated number of transfer bytes from the sending one of the local devices 21 and 22. The master device 10 transmits the information of the designated number of transfer bytes, which has been received from the sending local device 21 or 22, to the target device 31.

In a step S3, the data-receiving section 11 of the master device 10 requests the sending local device 21 or 22 to read data.

In a step S4, the sending local device 21 or 22 receives the request for reading data from the master device 10.

In a step S5, the sending local device 21 or 22 determines whether or not it can normally transfer the data. When it is determined that the sending local device 21 or 22 can normally transfer the data, the process proceeds to a step S6, whereas when it is determined that the device 21 or 22 cannot normally transfer the data, the process proceeds to a step S8.

In the step S6, the sending local device 21 or 22 transmits data to be transferred to the target device 31, to the master device 10.

In a step S7, the data-receiving section 11 of the master device 10 receives the data transmitted from the sending local device 21 or 22.

In the step S8, the sending local device 21 or 22 transmits an abort signal to the master device 10.

In a step S9, the abort signal-receiving section 13 of the master device 10 receives the abort signal transmitted from the sending local device 21 or 22.

In a step S10, the dummy data-generating section 14 of the master device 10 generates dummy data in response to the abort signal received by the abort signal-receiving section 13. Further, the erroneous parity data-generating section 15 generates erroneous parity data indicating that the dummy data generated by the dummy data-generating section 14 in response to the abort signal received by the abort signal-receiving section 13 is a dummy. It should be noted that the steps S8 to S10 enclosed by a dotted square indicate a flow executed when the sending local device 21 or 22 aborts.

In a step S11, the data-transmitting section 12 of the master device 10 converts the format of the data received by the data-receiving section 11 to a format conforming to the standard of the PCI-X bus. Further, the data-transmitting section 12 converts the format of the dummy data generated by the dummy data-generating section 14 to the format conforming to the standards of the PCI-X bus.

In a step S12, the data-transmitting section 12 of the master device 10 delivers the data and the dummy data, the formats of which have been converted, to the target device 31 via the PCI-X bus 42.

In a step S13, the transfer completion-determining section 16 of the master device 10 determines whether or not the data-transmitting section 12 has transmitted the designated number of transfer bytes of data to the target device 31. If the designated number of transfer bytes of data have been transmitted, the data transfer process is terminated, whereas if the designated number of transfer bytes of data have not been transmitted, the process proceeds to the step S3.

In a step S14, the target device 31 receives the data from the master device 10 via the PCI-X bus 42.

In a step S15, the target device 31 determines whether or not a parity error has been detected of the received data. If a parity error has been detected of the received data, the process proceeds to a step S18, whereas if no parity error has been detected of the received data, the process proceeds to a step S16.

In the step S16, the target device 31 processes the received data.

In a step S17, the target device 31 determines whether or not the designated number of transfer bytes of data have been received from the master device 10. If the designated number of transfer bytes of data have been received, the data transfer process is terminated, whereas if the designated number of transfer bytes of data have not been received, the process proceeds to the step S14.

In the step S18, the target device 31 notifies the master device 10 that a parity error has occurred.

In a step S19, the master device 10 receives the notification of the parity error from the target device 31.

In a step S20, the master device 10 performs the data retransfer process. The master device 10 proceeds to the step S2 after completion of transfer of all the data.

As described hereinabove, in response to reception of an abort signal from one of the local devices 21 and 22 as a sender of data, the master device 10 transmits dummy data and erroneous parity data as remaining data to be transferred. This makes it possible to complete data transfer and avoid a protocol violation to thereby prevent the PCI-X bus 42 from hanging up.

Further, even if the target device 31 as a recipient of the data, receives the dummy data, it can recognize, based on the erroneous parity data, that the received data is a dummy. The master device 10 receives the notification of a parity error from the target device 31, whereby it can carry out the data retransfer process.

The one of the local devices 21 and 22 as the sender can notify the master device 10 that it aborts, in any timing without being conscious of the ADB.

The data transfer device of the present invention is configured such that in response to reception of an abort signal from a sender of data, dummy data and erroneous parity data are transmitted as remaining data to be transferred. This makes it possible to complete transfer of data and avoid a protocol violation to thereby prevent the PCI-X bus 42 from hanging up.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A data transfer device for transferring data via a PCI-X bus, comprising:
an abort signal-receiving section that receives an abort signal from a sender of the data;
a dummy data-generating section that generates dummy data when the abort signal is received;
an erroneous parity data-generating section that generates erroneous parity data for indicating that the dummy data is a dummy; and
a data-transmitting section that transmits the dummy data and the erroneous parity data to a recipient of the data via the PCI-X bus.

2. The data transfer device according to claim 1, further comprising a transmitted data count-determining section that determines whether or not the data and the dummy data have been transmitted in an amount corresponding to a number of data pieces to be transferred which is designated by the sender.

3. The data transfer device according to claim 2, wherein when it is determined by said transmitted data count-determining section that the data and the dummy data have been transmitted in the amount corresponding to the designated number of data pieces to be transferred, said data-transmitting section terminates transmission of the dummy data and the erroneous parity data.

4. The data transfer device according to claim 2, wherein information of the designated number of data pieces to be transferred is transmitted from the sender at the start of transfer of the data.

5. The data transfer device according to claim 1, further comprising a retransfer processing section that performs a retransfer process for retransferring the data when notification of a parity error is received from the recipient.

6. A data transfer method for a data transfer device, for transferring data via a PCI-X bus, comprising the steps of:
generating dummy data, and erroneous parity data for indicating that the dummy data is a dummy, when an abort signal is received from a sender of the data; and
transmitting the dummy data and the erroneous parity data via the PCI-X bus to a recipient of the data.

7. An information processing apparatus for transferring data via a PCI-X bus, comprising:
an abort signal-receiving section that receives an abort signal from a sender of the data;
a dummy data-generating section that generates dummy data when the abort signal is received;
an erroneous parity data-generating section that generates erroneous parity data for indicating that the dummy data is a dummy; and
a data-transmitting section that transmits the dummy data and the erroneous parity data to a recipient of the data via the PCI-X bus.
